(19) United States
(12) Patent Application Publication
(10) Pub. No.: US 2023/0056325 A1
(43) Pub. Date: Feb. 23, 2023

(54) METHOD AND APPARATUS FOR INTEGRATING OF DATA

(71) Applicant: KOREA ELECTRONICS TECHNOLOGY INSTITUTE, Seongnam-si (KR)

(72) Inventors: Jae Won MOON, Seoul (KR); Seung Woo KUM, Yongin-si (KR); Seung Taek OH, Seoul (KR); Mi Seon YU, Seoul (KR); Ji Soo HWANG, Incheon (KR)

(21) Appl. No.: 17/496,901

(22) Filed: Oct. 8, 2021

(30) Foreign Application Priority Data
Aug. 12, 2021 (KR) 10-2021-0106656
Aug. 12, 2021 (KR) 10-2021-0106657

(51) Int. Cl. G06F 16/25

(52) U.S. Cl. CPC G06F 16/254

(57) ABSTRACT

The present invention relates to a method and apparatus for integrating data, including the steps of receiving a data integration signal, extracting at least two types of source data associated with the data integration signal from collected source data, confirming data information of the extracted source data, setting a data regeneration method for integration of the extracted source data based on the data information, setting a regeneration period for integration of the extracted data based on the data information, and performing integration of the extracted data based on the regeneration method and the regeneration period, and it is possible to apply to other exemplary embodiments.

### TECHNICAL FIELD

The present invention relates to a method and apparatus for integrating data.

### BACKGROUND ART

The development of industrial technology and information and communication technology generates a significant amount of information and data. In particular, due to the development and spread of the Internet of things (IoT) technology, numerous data obtained from various sensors are generated. Such data has time information about the time when the data was generated, and has a structure in which necessary information is additionally stored based on a timestamp which is a specific moment in time flow.

However, since data having time information is not stored in a standardized format, a pre-processing step is necessarily required to process or analyze data by using the data. Accordingly, there are problems such as waste of manpower, waste of time for pre-processing and the like that may occur. In addition, in order to process and analyze such data, the user has to manually extract, process and analyze data suitable for his/her purpose such that it is difficult for users with low professionalism to utilize a large amount of data.

In addition, since data information such as data collection periods, data ranges, data formats and the like are all different, there are problems such as waste of manpower, waste of time for pre-processing and the like that may occur.

Therefore, in order to solve these problems, the need for a method that can convert and generate data according to time information into meaningful time-series data to facilitate data processing and analysis has emerged, and recently, since data fusion in various fields is required, the need to integrate, process and manage heterogeneous data more easily is emerging.

### DISCLOSURE

### Technical Problem

The exemplary embodiments of the present invention for solving these conventional problems are directed to providing a method and apparatus for integrating data, which are capable of generating table data for a plurality of data having different data information, and supplementing data requiring supplementation in the generated table data to analyze heterogeneous data more easily.

The exemplary embodiments of the present invention for solving these conventional problems are directed to providing a method and apparatus for integrating data, which are capable of more easily performing analysis of time-series data through processing of converting and generating source data into meaningful time-series data using parameters of source data having time information.

### Technical Solution

The method for integrating data according to an exemplary embodiment of the present invention includes receiving a data integration signal, extracting at least two types of source data associated with the data integration signal from collected source data, confirming data information of the extracted source data, setting a data regeneration method for integration of the extracted source data based on the data information, setting a data regeneration period for integration of the extracted data based on the data information, and performing integration of the extracted data based on the regeneration method and the regeneration period.

In addition, the step of receiving a data integration signal is receiving a data integration range including a data integration start time and a data integration end time, and a selection signal for the at least two types of source data as the data integration signal.

In addition, the step of confirming data information is confirming the data information including a data type, data dependency, data collection period and data generation time for the extracted source data.

In addition, the data type includes a Numeric type, a Category type and a String type.

In addition, the data dependency is whether data values included in each of the extracted source data form an organic relationship with each other.

In addition, the data generation time indicates whether data values included in each of the extracted source data occur continuously or aperiodically.

In addition, after the step of confirming data information, it further includes confirming a possibility of whether the extracted source data is regenerated.

In addition, the step of setting a regeneration method is setting the regeneration method under a condition including an average value, a median value, a maximum value, a minimum value and a value in a specific order for data values included in each of the extracted source data within the data integration range based on the data information.

In addition, the step of setting a regeneration method is setting the regeneration method by confirming whether upsampling or downsampling is applied to the extracted source data.

In addition, the step of setting a regeneration period is setting the regeneration period as a reference for integrating the extracted source data.

Moreover, the apparatus for integrating data according to an exemplary embodiment of the present invention includes an input device for inputting a data integration signal, and a controller for extracting at least two types of source data associated with the data integration signal from collected source data to confirm data information on the source data, and integrating the extracted source data according to a regeneration method and a regeneration period which are set based on the data information.

In addition, the data integration signal includes a data integration range including a data integration start time and a data integration end time, and a selection signal for the at least two types of source data.

In addition, the data information includes a data type, data dependency, data collection period and data generation time for the extracted source data.

In addition, the data type includes a Numeric type, a Category type and a String type.

In addition, the data dependency is whether data values included in each of the extracted source data form an organic relationship with each other.

In addition, the data generation time indicates whether data values included in each of the extracted source data occur continuously or aperiodically.

In addition, the controller confirms a possibility of whether the extracted source data is regenerated.

In addition, the controller sets the regeneration method under a condition including an average value, a median value, a maximum value, a minimum value and a value in a specific order for data values included in each of the extracted source data within the data integration range based on the data information.

In addition, the controller sets the regeneration method by confirming whether upsampling or downsampling is applied to the extracted source data.

In addition, the controller sets the regeneration period as a reference for integrating the extracted source data.

Moreover, in the apparatus for integrating data according to an exemplary embodiment of the present invention, the source data has a plurality of parameter information including time information, and the controller extracts source data corresponding to at least one type of a first type, a second type, a third type and a fourth type from table data generated as the source data, and processes the extracted source data to confirm data information.

### Advantageous Effects

As described above, the method and apparatus for integrating data according to the present invention has effects of generating table data for a plurality of data with different data information and supplementing the data requiring supplementation in the generated table data, thereby more easily performing the integration of heterogeneous data, and through this, it is possible to perform the analysis of heterogeneous data more easily.

### DESCRIPTION OF DRAWINGS

FIG. 1 is a diagram illustrating the apparatus for integrating data according to an exemplary embodiment of the present invention.

FIG. 2 is a flowchart for describing the method for integrating data according to an exemplary embodiment of the present invention.

FIG. 3 is a detailed flowchart for describing the method for supplementing data for data integration according to an exemplary embodiment of the present invention.

FIGS. 4 to 6 are exemplary diagrams for describing the method for integrating data according to an exemplary embodiment of the present invention.

FIG. 7 is a flowchart for describing the method for integrating data according to time information according to an exemplary embodiment of the present invention.

FIGS. 8 to 11 are exemplary diagrams for describing the method for integrating data according to time information according to an exemplary embodiment of the present invention.

### MODES OF THE INVENTION

Hereinafter, preferred exemplary embodiments according to the present invention will be described in detail with reference to the accompanying drawings. The detailed description set forth below in conjunction with the accompanying drawings is intended to describe the exemplary embodiments of the present invention and is not intended to represent the only exemplary embodiments in which the present invention may be practiced. In order to clearly describe the present invention in the drawings, parts irrelevant to the description may be omitted, and the same reference numerals may be used for the same or similar components throughout the specification.

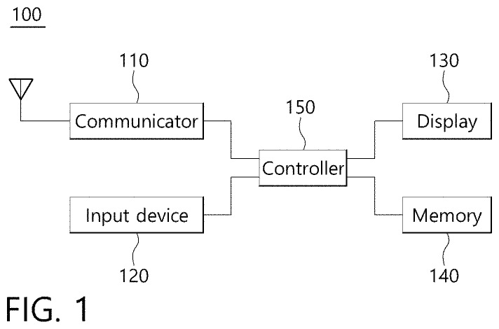

FIG. 1 is a diagram illustrating the apparatus for integrating data according to an exemplary embodiment of the present invention.

Referring to FIG. 1, the apparatus for integrating data 100 (hereinafter, referred to as an electronic device 100) according to the present invention includes a communicator 110, an input device 120, a display 130, a memory 140 and a controller 150.

The communicator 110 performs communication with an external server (not illustrated). The communicator 110 collects source data including time information from an external server and provides the same to the controller 150. To this end, the communicator 110 may perform wireless communication such as 5^{th} Generation communication (5G), Long Term Evolution-Advanced (LTE-A), Long Term Evolution (LTE), Wireless Fidelity (Wi-Fi) and the like.

The input device 120 includes at least one input means for generating input data in response to a user input of the electronic device 100. The input device 120 may include a keypad, a dome switch, a touch panel, a jog shuttle, a touch key, a menu button and the like.

The display 130 displays display data associated with the operation of the electronic device 100. The display 130 includes a liquid crystal display (LCD), a light-emitting diode (LED) display, an organic light-emitting diode (OLED) display, a micro-electro mechanical systems (MEMS) display and an electronic paper display. The display 130 may be implemented as a touch screen in combination with the input device 120.

The memory 140 stores operation programs of the electronic device 100. In particular, the memory 140 stores source data in the form of a table. The memory 140 stores a program for confirming data information on the source data, and stores a program for integrating the source data. In addition, the memory 140 stores a table in which source data is integrated. The memory 140 stores time-series data generated under the control of the controller 150.

The controller 150 generates a timestamp for each type of source data collected from the communicator 110 and table data having a data value corresponding to the timestamp, and stores the same in the memory 140. The controller 150 receives a data integration signal for integrating at least two types of source data in the table data from the input device 120. In this case, the data integration signal may include a data integration range including a data integration start time and a data integration end time, and a selection signal for at least two types of source data to be integrated.

The controller 150 extracts two types of source data from the table data, but extracts only source data corresponding to the integration start time and the integration end time. The controller 150 confirms the data type, data dependency, data collection period and data generation time of the extracted source data.

In this case, the data type includes a Numeric type, a Category type and a String type. In the case of numbers that are available for numerical operation, the data type may be classified as the Numeric type, and in the case of numbers, symbols and texts which are a string form and not available for numerical operation and in which there are only a predetermined number of variables, the data type may be classified as the Category type, and in the case of unstructured string data, the data type may be classified as the String type. Data dependency means whether data values included in each of the extracted source data form an organic relationship with each other. The data collection period refers to a period during which data is collected, such as 1 minute, 10 minutes, 1 hour, no period or the like. The data generation time refers to a time point as to whether data values included in each of the extracted source data are continuously generated or aperiodically generated.

The controller 150 generates table data from the source data collected from the communicator 110. To this end, the controller 150 confirms a plurality of parameter information included in the source data, and aligns the source data based thereon to generate table data. In this case, the parameter information may include a plurality of parameters, a plurality of parameter names and a plurality of parameter values, and the plurality of parameters may be as shown in Table 1 below. In this case, parameters of DB Name, Measurement Name, File Path, Data_format, Encoding and Src_type may be essential parameters, and Selected_time, Selected_datas, Selected_columns, Duplicated_time_columm_processing_method and the like may be additional parameters. Table 1 corresponds to one example and is not necessarily limited thereto, and changes may be applied according to the type of source data or time-series data to be generated.

TABLE 1

| Parameter | Description | Data type |
|---|---|---|
| DB Name | Database name | string |
| Measurement | Measurement name | string |
| Name | | |
| File Path | Data location | string |
| Data_format | Format of data values | string, list |
| | of time information | |
| Selected_ | Column name of data | string, |
| time | including time information | dictionary |
| Selected_ | Specific values existing in | list |
| datas | specific columns to be | (dictionary) |
| | saved | |
| Selected_ | Name of specific columns | list, |
| columns | to be saved or name of | dictionary |
| | columns to be changed | |
| Duplicated_ | Method of processing | string |
| time_ | duplicate time information | |
| column_ | values (choose_first, | |
| processing_ | choose_final, sum, | |
| method | average, min, max, etc.) | |
| Encoding | Data encoding method | string |
| Src_type | Data file format | string |

After the controller 150 generates the source data as table data based on the parameters shown in Table 1 above, when a generation signal for generating the time-series data is received from the input device 120, the type of condition for generating the time-series data is confirmed. According to an exemplary embodiment of the present invention, generating time-series data is a data pre-processing step for integrating data, and may be included in the step of confirming data information of the extracted source data. In this case, the type of condition may include a first type, a second type, a third type and a fourth type. More specifically, the first type is a condition for generating time-series data by extracting source data satisfying at least one upper condition from table data based on time information. The second type is a condition for generating time-series data by extracting source data satisfying at least one upper condition from table data based on time information and at least one lower condition included in the upper condition. The third type is a condition for generating time-series data by extracting source data to which any one of a first value, last value, maximum value, minimum value, average value, sum and deletion of duplicated source data is applied from the source data when there is a plurality of source data at the same time. The fourth type is a condition for generating time-series data by integrating source data in which time information is divided into a plurality of columns in table data into one column.

The controller 150 extracts source data based on any one type of the first to fourth types. The controller 150 generates time-series data from the extracted source data and displays the generated time-series data on the display 130. Through this, the present invention has an effect of more easily performing the analysis of time-series data through processing of converting source data having time information into meaningful time-series data based on parameters.

When the data information is confirmed, the controller 150 confirms a possibility of whether data is regenerated based on the data information. If data regeneration is not possible, the controller 150 deletes data that cannot be regenerated or terminates data integration. Conversely, if data regeneration is possible, the controller 150 sets a data regeneration method and a data regeneration period.

More specifically, the controller 150 sets a data regeneration method using a general interpolation method or a statistical method according to the data type. In addition, the controller 150 may set the data regeneration method according to whether upsampling or downsampling is applied. In addition, when integrating at least two types of source data, the controller 150 may set the data regeneration period as a period which is set by any one of a period of the source data having the smallest period, a period of the source data having the largest period, an average value and a median value of the periods of at least two types of source data, and a value which is determined by other statistical methods or the user.

The controller 150 performs the integration at least two types of source data extracted by the data integration signal using the set data regeneration method and data regeneration period. In this case, the controller 150 identifies data that needs to be supplemented when integrating the source data, and performs data integration by performing the supplementation of the confirmed data.

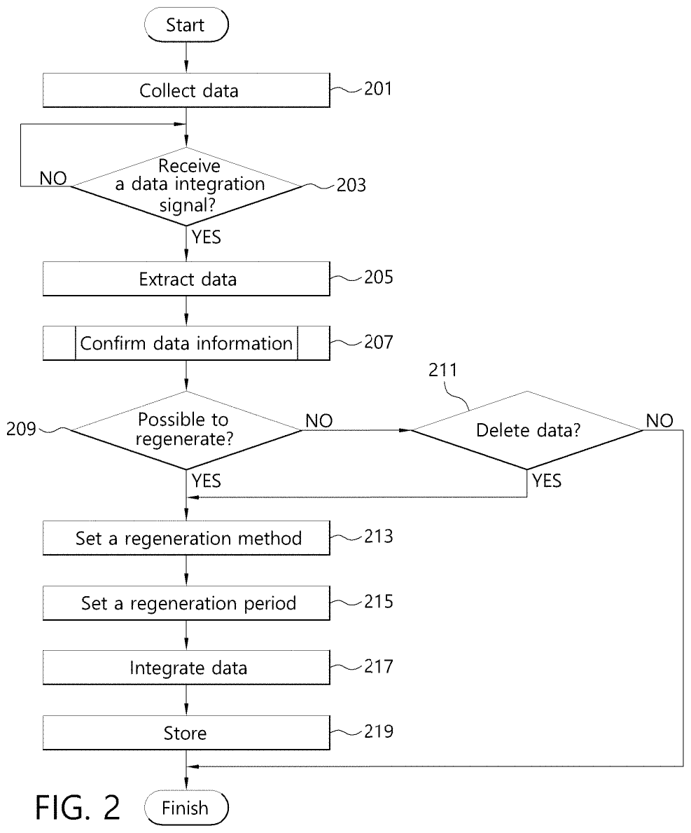

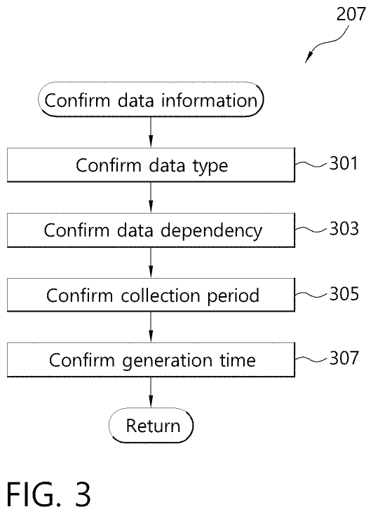

FIG. 2 is a flowchart for describing the method for integrating data according to an exemplary embodiment of the present invention. FIG. 3 is a detailed flowchart for describing the method for supplementing data for data integration according to an exemplary embodiment of the present invention.

Referring to FIGS. 2 and 3, in step 201, the controller 150 collects source data received from an external server (not illustrated) through the communicator 110. In this case, the source data is data received from various external servers, and may be data including time information. The source data is stored in the memory 140 by generating table data having a timestamp and a data value corresponding to the timestamp for each type of data, respectively.

In step 203, the controller 150 confirms whether a data integration signal for integrating at least two types of source data in the table data is received from the input device 120. In this case, the data integration signal may include a data integration range including a data integration start time and a data integration end time, and a selection signal for at least two types of source data to be integrated. If the data integration signal is received in step 203, the controller 150 performs step 205, and if the data integration signal is not received, the controller 150 waits for the reception of the data integration signal.

In step 205, the controller 150 extracts two types of source data from the table data, but only extracts source data corresponding to the integration start time and the integration end time. In step 207, the controller 150 confirms data information of the extracted source data. Step 207 will be described in more detail with reference to FIG. 3.

In step 301, the controller 150 confirms the data type of the extracted source data. In this case, the data type includes a Numeric type, a Category type and a String type. In the case of numbers that are available for numerical operation, the data type may be classified as the Numeric type, and in the case of numbers, symbols and texts which are a string form and not available for numerical operation and in which there are only a predetermined number of variables, the data type may be classified as the Category type, and in the case of unstructured string data, the data type may be classified as the String type.

In step 303, the controller 150 confirms the data dependency of the extracted source data. Data dependency means whether data values included in each of the extracted source data form an organic relationship with each other.

In step 305, the controller 150 confirms the collection period of the extracted source data. The data collection period refers to a period during which data is collected, such as 1 minute, 10 minutes, 1 hour, no period or the like.

In step 307, the controller 150 includes the data generation time of the extracted source data. The data generation time refers to a time point as to whether data values included in each of the extracted source data are continuously generated or aperiodic ally generated.

When the confirmation of the data information is completed as described above, the controller 150 returns to step 209 of FIG. 2. In step 209, the controller 150 confirms whether data may be regenerated by using the extracted source data. For example, the controller 150 confirms a possibility of whether data is regenerated as shown in Table 2 below based on the data information confirmed in FIG. 3. In this case, Table 2 is an example for the convenience of description and is not necessarily limited thereto, and various modifications are possible.

TABLE 2

| | | Data | Data | | General | |
|---|---|---|---|---|---|---|
| | Data | collection | generation | | interpolation | |
| Data type | dependency | period | time | Example | method | Statistical method |
| Numeric | Independent | ◯ | Continuous | Air quality and | ◯ | ◯ |
| | | | | temperature data | | |
| | | | | collected in minutes | | |
| | | X | Continuous | Irregularly collected | ◯ | ◯ |
| | | | | air quality and | | |
| | | | | temperature data | | |
| | | | Aperiodic | Cumulative number of | ◯ | ◯ |
| | | | | visitors reflecting the | | |
| | | | | arrival of new visitors | | |
| | Dependent | ◯ | Continuous | Total number of traffic | X | Limited regeneration by |
| | | | | accidents per day | | dividing or accumulating |
| | | | | | | numbers according to |
| | | | | | | upsampling and |
| | | | | | | downsampling |
| | | X | Aperiodic | Number of visitors | X | Change to the value of the |
| | | | | when visitors visit the | | nearest timestamp among |
| | | | | store | | newly created timestamps |
| Category | Independent | ◯ | Continuous | Level indicating | X | - If the category value |
| | | | | good or bad | | can be changed to a |
| | | | | air quality and | | numeric value, |
| | | | | temperature data | | it is generated by |
| | | | | collected in minutes | | utilizing the |
| | | | | | | interpolation method |
| | | | | | | and changed back |
| | | | | | | to the category |
| | | | | | | - If it cannot be changed |
| | | | | | | to a numeric value, |
| | | | | | | the closest |
| | | | | | | timestamp value is |
| | | | | | | copied and used |
| | | X | Continuous | Level of irregularly | ◯ | |
| | | | | collected air quality | | |
| | | | | and temperature data | | |
| | | | Aperiodic | Level of cumulative | ◯ | |
| | | | | number of visitors | | |
| | | | | reflecting the arrival of | | |
| | | | | new visitors | | |
| | Dependent | ◯ | Continuous | Weather per day unit | X | X |
| | | X | Aperiodic | Level values of | X | X |
| | | | | precipitation measured | | |
| | | | | on rainy days | | |

| | | |
|---|---|---|
| String | X | X |

That is, if at least one type of source data among the at least two types of source data extracted in this way is Category and the data is dependent, it is determined that data regeneration is impossible. In addition, when the data type is String, the controller 150 determines that data regeneration is impossible. If it is determined that data regeneration is impossible, the controller 150 performs step 211. In step 211, when a signal for deleting the corresponding data is received, the controller 150 deletes the data for which data regeneration is impossible, and then performs step 213. Conversely, in step 211, if a signal for deleting the corresponding data is not received, the controller 150 ends the data integration process. Conversely, as a result of confirmation in step 209, if the data type is Numeric, it is determined that data regeneration is possible using a general interpolation method or statistical method. In addition, if the data type is Category but the data is independent, the controller 150 determines that data regeneration is possible using any one of a general interpolation method and statistical method. If it is determined that data regeneration is possible, the controller 150 performs step 213.

In step 213, the controller 150 sets a data regeneration method for at least two types of source data. In this case, for each source data, a data regeneration method may be set based on the interpolation method or statistical method confirmed in Table 2. For example, the data regeneration method may be set as a condition including an average value, a median value, a maximum value, a minimum value and a value in a specific order for each type of data. In addition, the data regeneration method may be set by confirming whether upsampling or downsampling is applied.

For example, in the case of the Numeric type, various mathematical and statistical methods such as average value supplementation, neighbor value supplementation and the like may be set for a method of supplementing NaN values. In the case of the Category type, if it is possible to change to the Numeric type, after changing the data value to the Numeric type, the interpolated value may be set to be changed back to the Category type. In addition, if it is difficult to change to the Numeric type among the Category type, preset data may be selected such as selecting the data value that occurs most in a specific section, setting a preferred data value arbitrarily, setting the first or last data in the section or the like.

Subsequently, in step 215, the controller 150 sets a data regeneration period. In order to analyze and apply the integrated data, it is set because it is preferable that the integrated data has a certain period. In this case, the data regeneration period may be a period of the source data having the smallest period or a period of the source data having the largest period when at least two types of source data are integrated, or a period which is set by any one of the average value or the median value of a period for at least two types of source data, or a value which is determined by other statistical methods or the user.

In step 217, the controller 150 integrates at least two types of source data based on the regeneration method and the regeneration period which are set in steps 213 and 215. In this case, if the set regeneration period is smaller than the collection period of each source data, upsampling is applied to perform the integration of source data. Conversely, if the set regeneration period is greater than the collection period of each source data, downsampling is applied to perform the integration of source data. Although not illustrated, if there is an unsupplemented data value (NaN) after the integration of source data, the controller 150 applies a separate method to supplement the unsupplemented data. Subsequently, in step 219, the controller 150 stores the integrated data in the memory 140.

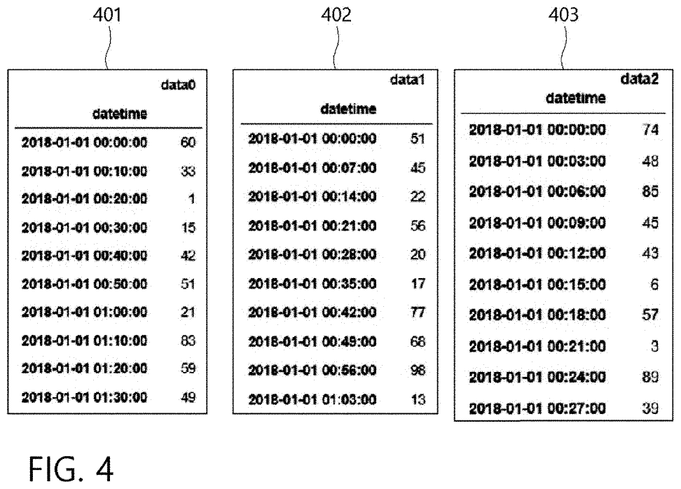

FIGS. 4 to 6 are exemplary diagrams for describing the method for integrating data according to an exemplary embodiment of the present invention.

Referring to FIGS. 4 to 6, FIG. 4 shows table data 401, 402 and 403 of source data extracted for data integration. The first table 401 includes a timestamp for data0 and a data value corresponding to the timestamp, the second table 402 includes a timestamp for data1 and a data value corresponding to the timestamp, and the third table 403 includes a timestamp for data2 and a data value corresponding to the timestamp.

The controller 150 selects data0 to data2 from the source data stored in the memory 140 according to the data integration signal, and extracts data between 2018-01-01 00:00:00, which is a data integration start time, and 2018-01-01 01:30:00, which is a data integration end time. In this case, datetime may mean a timestamp, and a numerical value corresponding to the timestamp may mean a data value.

The controller 150 may confirm data information of data0 to data2. As a result of confirming the data information, since the controller 150 may confirm that that data0 to data2 are Numeric-type data, data0 to data2 are independent data, the collection period of data0 is 10 minutes, the collection period of data1 is 7 minutes, and the collection period of data2 is 3 minutes, it can be confirmed that the data generation time is continuous.

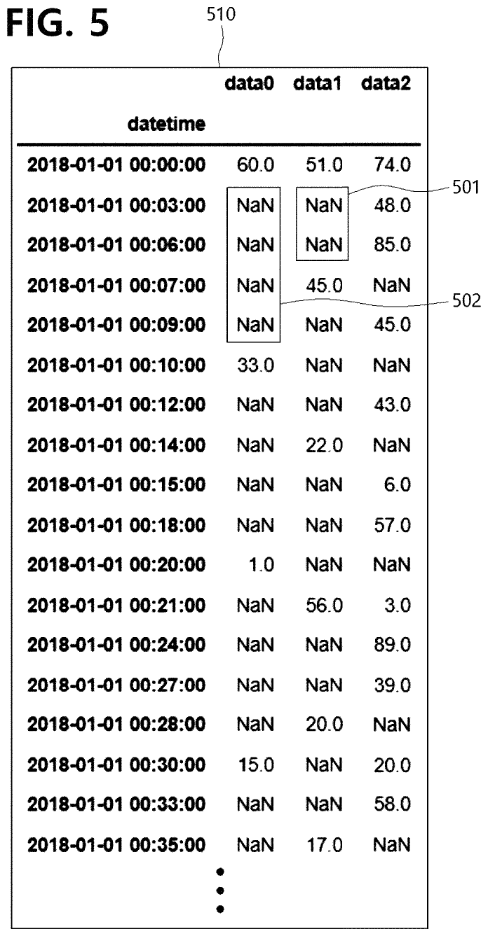

Accordingly, the controller 150 may confirm that data0 to data2 are all regeneratable data. The controller 150 generates table data 510 as shown in FIG. 5 by preferentially integrating data0 to data2. In this case, if data1 among data0 to data2 cannot be regenerated, the controller 150 may delete data1 and perform data integration only with data0 and data2, or cancel data integration.

When data0 to data2 are integrated, the controller 150 integrates the timestamps included in a first table 401 to a third table 403 in chronological order to create one column. The controller 150 adds NaN values 501 and 502 if there is no data value in the timestamp when the first table 401 to the third table 403 are integrated.

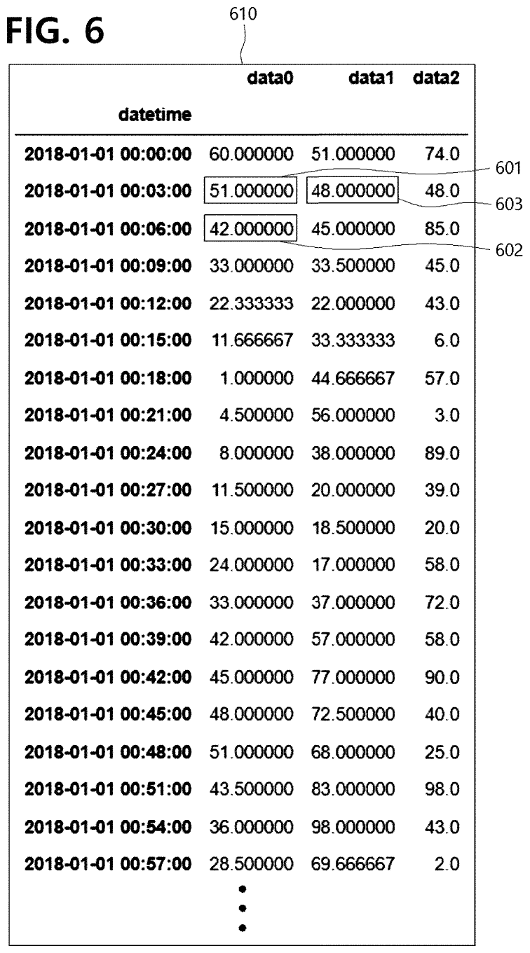

The controller 150 generates the finally integrated table data 610 as shown in FIG. 6 by applying the regeneration method and the regeneration period to the firstly integrated table data 510 as shown in FIG. 5. In this case, when the regeneration period is set to 3 minutes, the controller 150 displays data values for data0 to data2 in the table data 610 every 3 minutes based on 2018-01-01 00:00:00. In the case of data0 and data1, since the collection periods are 10 minutes and 7 minutes, respectively, which are longer than the regeneration period of 3 minutes, data0 and data1 may perform upsampling. In this case, the regeneration period is set to 3 minutes having the smallest period among the collection period of data0 of 10 minutes, the collection period of data1 of 7 minutes and the collection period of data2 of 3 minutes, and the regeneration period may be set to 10 minutes, which is the largest period, or 6.7 minutes, which is the average of the collection periods of data0 to data2.

More specifically, data values of 00:03:00, 00:06:00, 00:07:00 and 00:09:00 for data0 may be represented as NaN values as shown by reference numeral 501 in FIG. 5. In this case, the data regeneration method of data0 may be set to add a data value of, for example, 00:10:00 that appears first after the NaN values to 00:09:00. Then, the average value obtained by dividing the difference between the data value at 00:00:00 and the data value at 00:09:00 by the number of intervals between 00:00:00, 00:03:00, 00:00:06:00, and 00:09:00 may be calculated to set to add data values of empty sections between 00:03:00 and 00:06:00. Accordingly, the controller 150 calculates 9.0, which is a value obtained by dividing 27.0, which is a difference value of 33.0 by adding a data value of 00:09:00 to 60.0, which is a data value of 00:00:00, into 3 sections. The controller 150 generates table data 610 by adding 51.000000 to a data value of 00:03:00 and 42.000000 to a data value of 00:06:00 as shown by reference numerals 601 and 602 using the calculated value.

In addition, data values of 00:03:00 and 00:06:00 for data1 may be represented as NaN values as indicated by reference numeral 502 in FIG. 5. In this case, the data regeneration method of data1 may be set to add the first data value after the NaN values, for example, a data value of 00:07:00 to 00:06:00. In addition, it may be set to add a data value of 00:03:00 to an empty section by calculating an average value divided by the number of sections between 00:00:00, 00:03:00 and 00:06:00. Accordingly, the controller 150 calculates 3.0, which is a value obtained by dividing 6.0, which is a difference value between 51.0, which is a data value of 00:00:00, and 45.0, which is a data value of 00:06:00, into two sections. The controller 150 may generate the table data 610 by adding 48.000000 to a data value of 00:03:00 as shown in reference numeral 603 by using the calculated value. The controller 150 may perform data integration by changing the NaN values displayed in columns corresponding to data0 and data1 to the data values calculated through data regeneration for data0 and data1 in this way.

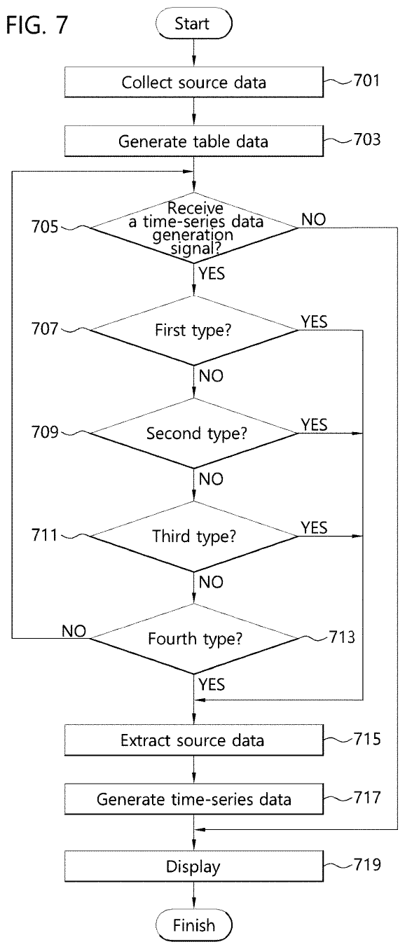

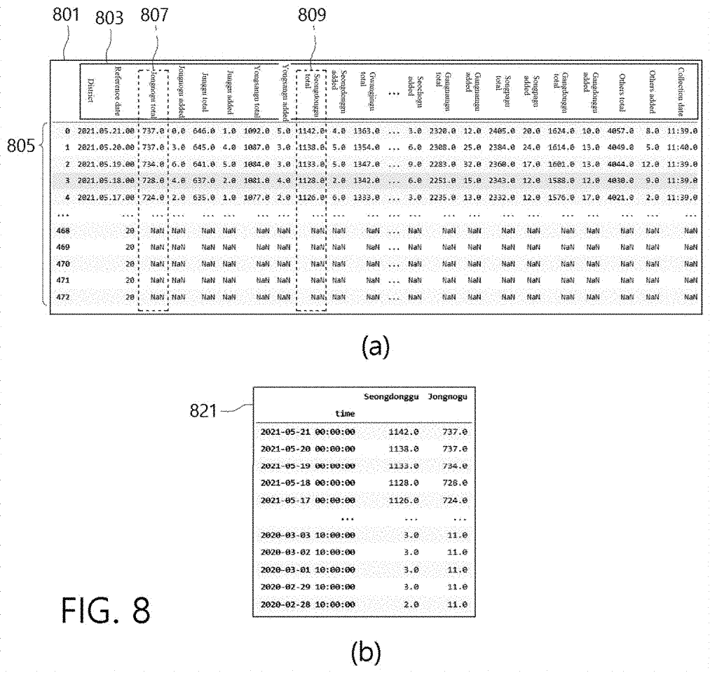

FIG. 7 is a flowchart for describing the method for integrating data according to time information according to an exemplary embodiment of the present invention. FIGS. 8 to 11 are exemplary diagrams for describing the method for integrating data according to time information according to an exemplary embodiment of the present invention.

Referring to FIGS. 7 to 11, in step 701, the controller 150 collects source data received from an external server (not illustrated) through the communicator 110. In this case, the source data is data received from various external servers, and preferably has a plurality of parameter information including time information. In step 703, the controller 150 checks a plurality of parameter information included in the source data to generate the source data as table data.

When table data is generated based on the parameter information identified in the source data as in step 703, in step 705, the controller 150 confirms whether a generation signal including a condition for generating time-series data is received. As a result of the confirmation in step 705, when the generation signal is received, the controller 150 performs step 707, and if the generation signal is not received, the controller 150 performs step 719 to display the generated table data on the display 130.

In step 707, if the condition included in the generation signal is a condition for generating time-series data as a first type, step 715 is performed, and if it is not a first type, step 709 is performed. In this case, the first type is a condition for generating time-series data by extracting source data satisfying at least one upper condition from table data based on time information. According to an exemplary embodiment of the present invention, generating time-series data is a data pre-processing step for integrating data, and may be included in the step of confirming data information of the extracted source data.

For example, in the table data 801 as shown in (a) of FIG. 8, the district, reference date, Jongnogu total, Jongnogu added, Junggu total, Junggu added, Yongsangu total, Yongsangu added, Seongdonggu total, Seongdonggu added, Gwangjingu total, . . . Seochogu added, Gangnamgu total, Gangnamgu added, Songpagu total, Songpagu added, Gangdongu total, Gangdonggu added, others total, others added and the collection date represent parameter names 803, and the source data displayed in each column associated with each parameter name 803 represents parameter values 805. The controller 150 may input from the input device 120 Jongnogu total and Seongdonggu total among the parameter names 803 of the table data 801 as shown in (a) of FIG. 8 as a condition for generating time-series data. In step 715, the controller 150 extracts source data of columns 807 and 809 whose parameter names correspond to Jongnogu total and Seongdonggu total from the table data 801 of (a) of FIG. 8.

In step 717, the controller 150 generates time-series data 821 from the extracted source data based on time information, which is the reference date of the district, and performs step 719. In this case, the generation signal may include a signal for changing the parameter names set to the reference date of the district, Jongnogu total and Seongdonggu total to time, Jongnogu, and Seongdonggu, respectively. In this case, when generating the extracted source data as time-series data, the controller 150 may change the parameter names to time, Jongnogu and Seongdonggu, respectively, as shown in (b) of FIG. 8.

If the condition included in the generation signal is not the first type in step 707, the controller 150 performs step 709. In step 709, if the condition included in the generation signal is a condition for generating time-series data in the second type, the controller 150 performs step 715, and if it is not the second type, the controller 150 performs step 711. In this case, the second type is a condition for generating time-series data by extracting source data that satisfies at least one upper condition from table data based on time information and at least one lower condition included in the upper condition.

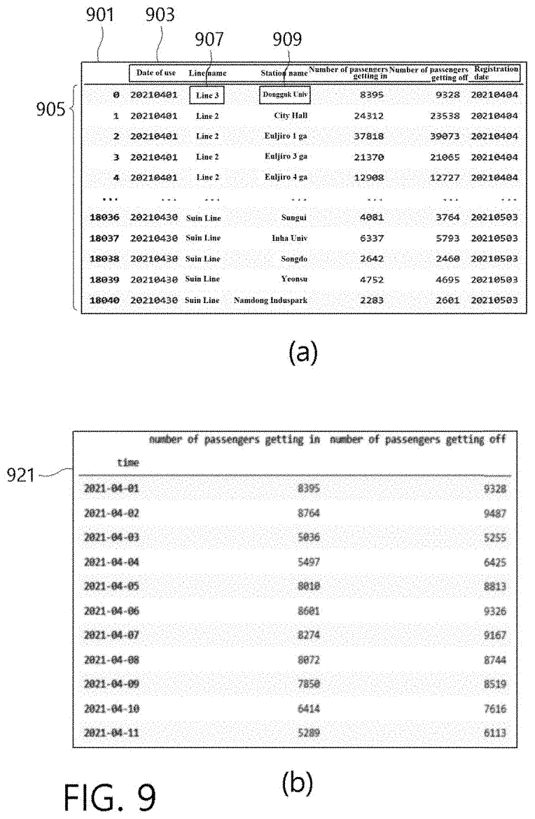

For example, in the table data 901 as shown in (a) of FIG. 9, the date of use, the line name, the station name, the total number of passengers getting in, the total number of passengers getting off and the registration date represent parameter names 903 and the source data displayed in each column of each parameter name 903 represents parameter values 905. The controller 150 may receive inputs of the line name and station name among the parameter names 903 of the table data 901 from the input device 120 as shown in (a) of FIG. 9 as an upper condition, and Line 3 907 and Dongguk University 909 among the parameter values 905 as a lower condition of each upper condition. In addition, the controller 150 may receive inputs of the total number of passengers getting in and the total number of passengers getting off associated with Line 3 907 and Dongguk University 909 from the input device 120 as a condition for generating time-series data.

In step 715, the controller 150 extracts source data whose parameter names are the line name and station name, and whose parameter values are Line 3 907 and Dongguk University 909 from the table data 901 of (a) of FIG. 9. Then, the controller 150 finally extracts only the source data corresponding to the total number of passengers getting in and the total number of passengers getting off from the extracted source data.

In this case, an exemplary embodiment of the present invention describes that the parameter values are set to Line 3 907 and Dongguk University 909 as an example, but is not necessarily limited thereto. For example, when the parameter value is set to Line 3 or higher and a station name from the Express Bus Terminal to the final station, the controller 150 checks a route passing through the Express Bus Terminal among Lines 3 and 4 to 9, and it is possible to extract the total number of passengers getting in and the total number of passengers getting off at all stations from the Express Bus Terminal to the final station among the confirmed lines from the source data.

In step 717, the controller 150 generates time-series data 921 based on time information, which is a date of use, from the extracted source data, and performs step 719. In this case, the generation signal may include a signal for changing the parameter names set by the date of use, the total number of passengers getting in and the total number of passengers getting off to time, number of passengers getting in and number of passengers getting off, respectively. In this case, the controller 150 may generate by changing the parameter names to time, number of passengers getting in and number of passengers getting off, respectively, as shown in (c) of FIG. 9.

If the condition included in the generation signal in step 709 is not the second type, the controller 150 performs step 711. In step 711, if the condition included in the generation signal is a condition for generating time-series data as a third type, the controller 150 performs step 715, and if it is not a third type, the controller 150 performs step 713. In this case, the third type is a condition for generating time-series data by extracting source data to which any one of a maximum value, minimum value, average value, sum and deletion of duplicated source data is applied from the source data when there is a plurality of source data at the same time.

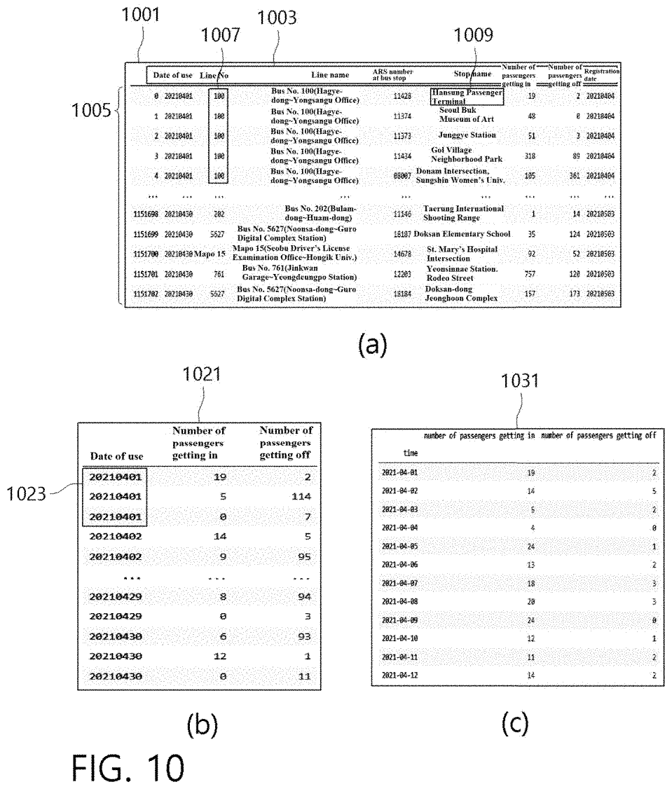

For example, in the table data 1001 as shown in (a) of FIG. 10, the date of use, the route number, the route name, the bus stop ARS number, the stop name, the total number of passengers getting in, the total number of passengers getting off and the registration date represent parameter names 1003, and the source data displayed in each column of each parameter name 1003 represents parameter values 1005. The controller 150 may receive inputs of the route name and the stop name among the parameter names 1003 of the table data 1001 from the input device 120 as shown in (a) of FIG. 10 and inputs of Bus No. 100 1007 and Hansung Passenger Terminal 1009 among the parameter values 1005. In addition, the controller 150 generates the total number of passengers getting in and the total number of passengers getting off associated with Bus No. 100 1007 and Hansung Passenger Terminal 1009 from the input device 120 as time-series data, but it may receive an input of a condition for generating only the maximum number of the total number of passengers getting in and the minimum value of the total number of passengers getting off at the same time as time-series data. To this end, the input device 120 may set parameter values of duplicated_time_column_processing_method to max and min.

In step 715, the controller 150 extracts source data in which the parameter names are the route number and stop name, and the parameter values are Bus No. 100 1007 and Hansung Passenger Terminal 1009 from the table data 1001 of (a) of FIG. 10. In addition, the controller 150 may extract only the source data corresponding to the total number of passengers getting in and the total number of passengers getting off from the extracted source data, as shown in the intermediate change table 1021 of (b) of FIG. 10. In the intermediate change table 1021 of (b) of FIG. 10, the controller 150 finally extracts only the source data having the maximum number of the total number of passengers getting in and the source data having the minimum number of the total number of passengers getting off from among the source data having the same time, that is, the same date of use 1023.

In this case, an exemplary embodiment of the present invention describes that the maximum value of the total number of passengers getting in and the minimum value of the total number of passengers getting off are conditions in which the route name is 100 and the stop name is Hansung Passenger Terminal, but is not necessarily limited thereto. For example, the source data may be extracted by calculating the average value or sum of the total number of passengers getting in and the total number of passengers getting off in which the route name is 100 and the stop name is Hansung Passenger Terminal, or by selecting any one of the first value or the last value or by deleting duplicated values.

In step 717, the controller 150 generates time-series data 1031 as shown in (c) of FIG. 10 based on the time information which is the date of use from the extracted source data, and performs step 719. In this case, the generation signal may include a signal for changing the parameter names set by the date of use, the total number of passengers getting in and the total number of passengers getting off to time, number of passengers getting in and number of passengers getting off, respectively. In this case, the controller 150 may generate by changing the parameter names to time, number of passengers getting in and number of passengers getting off, respectively, as shown in (c) of FIG. 10.

If the condition included in the generation signal is not the third type in step 711, the controller 150 performs step 713. In step 713, if the condition included in the generation signal is a condition for generating time-series data as a fourth type, the controller 150 performs step 715, and if it is not a fourth type, the controller 150 returns to step 705 and performs the above operations again. In this case, the fourth type is a condition for generating time-series data by integrating source data in which time information is divided into a plurality of columns in table data into one column.

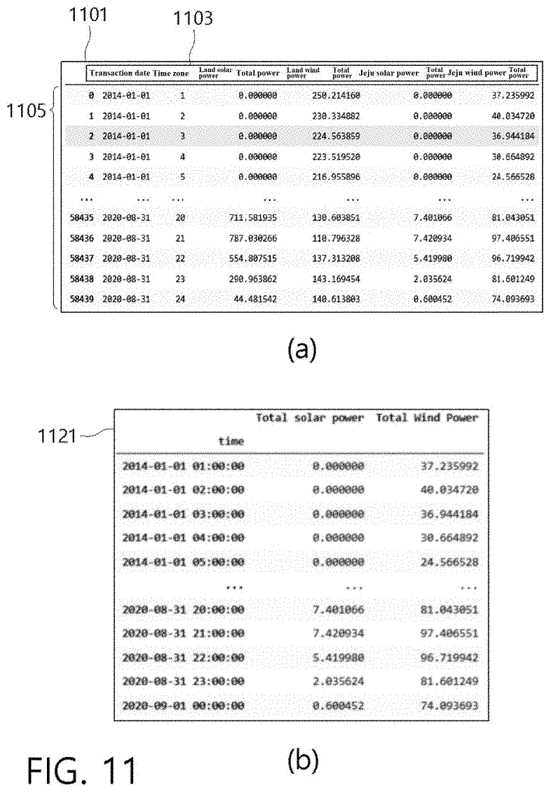

For example, in the table data 1101 as shown in (a) of FIG. 11, the transaction date, time zone, total generation amount of land solar power, total generation amount of land wind power, total generation amount of Jeju solar power and total generation amount of Jeju wind power represent parameter names 1103, and the source data displayed in each column of each parameter name 1103 represents parameter values 1105. The controller 150 integrates the transaction date and time zone, which are time information divided into a plurality of columns in the table data 1101 as shown in (a) of FIG. 11 from the input device 120 into a single column, and may receive an input of conditions for generating the total generation amount of Jeju solar power and the total generation amount of Jeju wind power as time-series data. In step 715, the controller 150 integrates the transaction dates and time zones separated into a plurality of columns in the table data 1101 of (a) of FIG. 11, and extracts source data for the total generation amount of Jeju solar power and the total generation amount of Jeju wind power.

In step 717, the controller 150 generates time-series data 1121 as shown in (b) of FIG. 11 based on the time information in which the transaction dates and time zones are integrated from the extracted source data, and performs step 719. In this case, the controller 150 changes 1, 2, 3, . . . , 24, which are parameter values described in the time zones, to 1:00:00, 2:00:00, 3:00:00, . . . , 00:00:00, and in the case of 24, the time-series data 1121 is generated by +1 to the transaction day. In addition, the generation signal may include a signal for changing parameter values, which are time information, the total generation amount of Jeju solar power and the total generation amount of Jeju wind power, to time, total solar power and total wind power, respectively. In this case, the controller 150 may change and generate the parameter names to time, total solar power and total wind power, respectively, as shown in (b) of FIG. 11.

Subsequently, in step 719, the controller 150 displays the time-series data (any one of 821, 921, 1031 and 1121) generated in step 717 on the display 130. Through this, the present invention has an effect of more easily performing the analysis of time-series data through processing of converting and generating source data having time information into meaningful time-series data by using parameters.

The exemplary embodiments of the present invention disclosed in the present specification and drawings are only provided for specific examples in order to easily explain the technical contents of the present invention and help the understanding of the present invention, and are not intended to limit the scope of the present invention. Therefore, the scope of the present invention should be interpreted as including all changes or modifications derived from the technical spirit of the present invention in addition to the exemplary embodiments disclosed herein.

1. An apparatus for integrating data, comprising:
an input device for inputting a data integration signal; and
a controller for extracting at least two types of source data associated with the data integration signal from collected source data to confirm data information on the source data, and integrating the extracted source data according to a regeneration method and a regeneration period which are set based on the data information.

2. The apparatus of claim 1, wherein the data integration signal includes a data integration range including a data integration start time and a data integration end time, and a selection signal for the at least two types of source data.

3. The apparatus of claim 2, wherein the data information includes a data type, data dependency, data collection period and data generation time for the extracted source data.

4. The apparatus of claim 3, wherein the data type includes a Numeric type, a Category type and a String type.

5. The apparatus of claim 3, wherein the data dependency is whether data values included in each of the extracted source data form an organic relationship with each other.

6. The apparatus of claim 3, wherein the data generation time indicates whether data values included in each of the extracted source data occur continuously or aperiodically.

7. The apparatus of claim 3, wherein the controller confirms a possibility of whether the extracted source data is regenerated.

8. The apparatus of claim 7, wherein the controller sets the regeneration method under a condition including an average value, a median value, a maximum value, a minimum value and a value in a specific order for data values included in each of the extracted source data within the data integration range based on the data information.

9. The apparatus of claim 8, wherein the controller sets the regeneration method by confirming whether upsampling or downsampling is applied to the extracted source data.

10. The apparatus of claim 9, wherein the controller sets the regeneration period as a reference for integrating the extracted source data.

11. The apparatus of claim 1, wherein the source data has a plurality of parameter information including time information, and
wherein the controller extracts source data corresponding to at least one type of a first type, a second type, a third type and a fourth type from table data generated as the source data, and processes the extracted source data to confirm data information.

12. The apparatus of claim 11, wherein the controller extracts source data, which satisfies at least one upper condition selected from the table data based on the time information, as the first type of data.

13. The apparatus of claim 11, wherein the controller extracts source data, which satisfies at least one upper condition selected from the table data and at least one lower condition included in the upper condition based on the time information, as the second type of data.

14. The apparatus of claim 13, wherein if there are multiple source data at the same time, the controller extracts source data, to which any one of a first value, a last value, a maximum value, a minimum value, an average value, a sum and a deletion of duplicated source data is applied from the source data, as the third type of data.

15. The apparatus of claim 14, wherein the controller extracts source data, in which the time information is divided into a plurality of columns from the table data, as the fourth type of data.

16. The apparatus of claim 15, wherein the controller integrates the time information divided into the plurality of columns in the extracted fourth type of data into one column.

17. The apparatus of claim 16, wherein the controller confirms the data information by arranging source data in chronological order, the source data being extracted as data corresponding to any one type of the first type to the fourth type.

18. A method for integrating data, comprising:
receiving a data integration signal;
extracting at least two types of source data associated with the data integration signal from collected source data;
confirming data information of the extracted source data;
setting a data regeneration method for integration of the extracted source data based on the data information;
setting a regeneration period for integration of the extracted data based on the data information; and
performing integration of the extracted data based on the regeneration method and the regeneration period.

19. The method of claim 18, wherein the receiving a data integration signal is receiving a data integration range including a data integration start time and a data integration end time, and a selection signal for the at least two types of source data as the data integration signal.

20. The method of claim 18, wherein the confirming data information is confirming the data information including a data type, data dependency, data collection period and data generation time for the extracted source data.
